(19) United States
(12) Patent Application Publication
(10) Pub. No.: US 2022/0287334 A1
(43) Pub. Date: Sep. 15, 2022

(54) SUPPLEMENTAL FLAVOR PACK FOR USE IN A TEA/COFFEE MAKER IN ASSOCIATION WITH A PRE-EXISTING BEVERAGE FILTER PACK AND METHOD OF USING SAME

(71) Applicant: Harris Tea Company LLC, Anaheim, CA (US)

(72) Inventors: Saikiran Chaluvadi, Moorestown, NJ (US); Ronnie Osborne, Woodstock, GA (US)

(21) Appl. No.: 17/199,162

(22) Filed: Mar. 11, 2021

(51) Int. Cl. A23L 2/56; B65D 85/808; A23L 2/60; A23L 27/00

(52) U.S. Cl. CPC A23L 2/56; B65D 85/808; A23L 2/60; A23L 27/82

(57) ABSTRACT

A supplemental flavor pack for use in a beverage brewing apparatus with a pre-existing beverage filter pack having a known beverage substrate. The supplemental flavor pack comprises a water permeable container; granulated flavor particles (contributing to a supplemental flavor profile); granulated acids (contributing to said supplemental flavor profile); and a bulking agent. The particle size of at least about 90 wt % of the components is above U.S. mesh 50 with less than or equal to about 1 wt % being above U.S. mesh 10. The component amounts are formulated to balance out the known beverage substrate while supplementing it with the supplemental flavor profile. A method of making a flavored brewed beverage with a pre-existing beverage filter pack and the supplemental flavor pack is also disclosed along with the method of producing a pre-existing beverage filter pack with a dried sugared tea.

### TECHNICAL FIELD

The present invention relates generally to beverages and more particularly to the convenient batch production of brewed beverages, such as iced tea, sweet iced tea, iced coffee, sweet iced coffee, and the like, with the option of supplemental flavoring. This invention has particular utility in the food service industry where patrons with differing tastes may desire, for example, either plain or flavored sweet iced tea.

### BACKGROUND

Brewed iced tea and even iced coffee have become commonplace offerings within the food service industry, including, for example, at buffet or cafeteria-style restaurants, diners, fast casual restaurants, fine dining, food trucks, institutional dining (e.g., educational facilities, hospitals, and hotels), and quick serve restaurants.

Some of these food service outlets offer “sweet tea.” A type of iced tea generally accepted to have originated in the Southern United States, “sweet tea” is generally iced tea with exceptionally large amounts of sweetener (usually sugar or simple syrup). According to one magazine article from August 2007, some sweet teas “can hit 22 Brix of sugar. That means that 22 percent of the liquid consists of dissolved sugar solids.” “I Wish I Lived in a Land of Lipton: What makes Southern sweet tea so special?” by Jeffrey Klineman (Slate Magazine, Aug. 8, 2007).

In food service outlets, sweet tea is often made by the servers in the front of the house. In some locations, servers make the sweet tea using an automatic drip coffee maker. In other locations, they use an automatic iced tea brewer. In other locations, a specialty iced tea maker is used. And in still other locations, servers may just boil a predetermined amount of hot water, pour the hot water (195-212° F.) into a pitcher containing a desired number of pre-filled tea bags, let the tea steep in the hot water for a few minutes, remove the tea bags, add a desired amount of sugar (or other sweetener), stir until the sugar appears mostly dissolved, add ice (usually in the form of cubes), and then serve.

The predetermined amount of water is most-often approximately 64 oz (i.e., 0.5 gallons), as that is a standard size for commercially available glass, coffee decanters. The strength/flavor of the resulting tea-infused hot water depends on a number of factors such as the type of tea (e.g., black, green, herbal), the particle size of the tea, the amount of tea (e.g., how many tea bags), the water temperature, the amount of time the tea dwells in the hot water. The amount of sweeter added depends on the type of sweetener used (e.g., aspartame, saccharin, sucralose, and sucrose/regular sugar) and the desired sweetness of the resulting iced tea. As noted above, some “sweet tea” can be as sweet as 22° Brix. More often, though, food service establishments strive for “sweet tea” to have a Brix between approximately 10° and 12° (i.e., 1° Brix is 1 gram of sucrose in 100 grams of solution). This level of sweetness requires approximately 1 pound of granulated sugar per 1 gallon of sweet tea.

Where an automatic drip coffee maker is used, the server removes the brew basket from the machine, places a desired quantity of tea (using either pre-filled tea bags or loose tea and a paper coffee filter) into the brew basket, places the brew basket back into the automatic drip coffee maker, places an empty decanter beneath the brew basket, and starts the brew cycle. During the brew cycle, a substantially pre-determined amount of hot water (e.g., 64 oz at 195-212° F.) showers down onto the tea disposed in the brew basket resulting in tea-infused hot water dripping into the decanter. When the brew cycle is finished, the resulting tea is poured into a pitcher (or other dispenser), and the desired amount of sweetener is added to the pitcher and stirred until visibly dissolved. Ice (usually in the form of cubes) is then added to the pitcher.

Where an automatic iced tea brewer is used, the server removes the brew basket from the machine, places a desired quantity of tea (using either pre-filled tea bags or loose tea and a paper coffee filter) into the brew basket, places the brew basket back into the automatic iced tea brewer, places an empty urn beneath the brew basket, and starts the brew cycle. During the brew cycle, a substantially pre-determined amount of hot water (e.g., 0.5, 1, 2, or 3 gallons at 195-212° F.) showers down onto the tea disposed in the brew basket resulting in tea-infused hot water dripping into the urn. In some automatic iced tea brewers, a second pre-determined amount of water is added to the urn (bypassing the brew basket) thus diluting the more concentrated tea that drips into the urn from the brew basket. Following completion of the brew cycle, the desired amount of sweetener is added into the urn and stirred until visibly dissolved. Ice is usually added to glasses into which the warm tea is dispensed from a faucet on the front of the urn.

Where a specialty iced tea maker is used, such as the Mr. Coffee® Iced Tea and Iced Coffee Maker (distributed by Sunbeam® Products of Boca Raton Fla.), the server fills the pitcher with a predetermined amount of cold water (e.g., 1-3 quarts), removes the brew basket from the machine, adds the cold water to a reservoir of the machine, places a desired quantity of tea (using either pre-filled tea bags or loose tea and a paper coffee filter) along with a desired amount of sugar, lemon or other flavorings into the brew basket, places the brew basket back into the machine, fills the pitcher with a predetermined amount of ice cubes, places the pitcher beneath the brew basket, and starts the brew cycle. During the brew cycle, the pre-determined amount of hot water added to the machine showers down onto the tea, sugar, lemon, and other flavorings disposed in the brew basket resulting in sweetened, flavored, tea-infused hot water dripping into the pitcher onto the ice. As the brew cycle continues, the hot tea melts a substantial amount of the ice cubes disposed in the pitcher diluting and cooling the liquid pouring into the pitcher from the brew basket. The resulting iced tea is poured from the pitcher into glasses.

There was a potential lack of consistency in the resulting flavor profile of sweet tea made using the foregoing methods. Some servers may have used more tea, some less. Some added more sugar, some less. Some stirred the sweetener sufficiently, others not so much. Some may have even added the sweetener long after the tea had cooled making it more difficult to dissolve the sweetener into the tea. So, a filter pouch was developed that contained both tea and sweetener in a set ratio for use in food service outlets primarily in association with automatic iced tea brewers. One such pouch was marketed by Southern Visions, LLP in “commercial sizes” (e.g., producing 1, 1.5 or 3 gallons of plain or flavored (e.g., raspberry, watermelon, mango and peach) sweet tea). For example, the 3-gallon filter pack weighs on the order of 3 pounds and takes up quite a bit of shelf space. Other manufacturers produce commercial sizes of sweet tea. Some use sugar, others use artificial sweeteners.

One such pouch has been described by Southern Visions in one or more published documents, including, but not limited to U.S. Pat. Nos. 9,468,222; 9,468,330; 9,549,634; 9,725,232; 10,071,852; 10,093,480; and 10,130,209 to Stewart, et al. These Stewart patents disclose a blend of tea particles and sugar granules in specified ratios contained in a water permeable mesh pouch for use in a brew basket of an automated tea brewing machine. They also disclose that the sugar granules should be bigger than U.S. mesh 35 (and as big as U.S. mesh 3) and further disclose that one way to make sugar granules that fall within the desired range is to take smaller sugar particles and form agglomerates, which can be made large enough to require that the agglomerated pellets be broken into chunks that fall in the desired size range. These patents also disclose the possibility of using coffee grounds or flavored concentrate (e.g., lemonade, limeade, pink lemonade, peach, mango, raspberry, lemon, or fruit punch) instead of or in addition to tea/coffee as well as sweeteners such as agave, coconut sugar, honey, maple syrup, molasses, stevia, sugar alcohols instead of or in addition to granulated sugar. The later Stewart patents also disclose having the beverage particles (e.g. coffee, tea, lemonade) in one pouch and the granulated sweetener in a second pouch, which may be heat-sealed together.

Persons of ordinary skill in the art have been long familiar with paper filter packs containing both tea leaves and sweetener prior to the disclosures in the Stewart patents. See, e.g., U.S. Pat. No. 5,895,672 to Cooper and Australian Patent Publication No. 2011/100497 to Chegodaev. Moreover, the applicant of the present inventive concepts was selling pre-sweetened, paper-filter tea bags in the United States as early as February 2013, which contained sufficient amounts of black tea and sucralose to produce 1 quart of sweet tea per 1 bag of tea, with a sweetness equivalency of 10 to 12 Brix. In other words, Stewart, U.S. Pat. No. 9,468,222 did not provide the first teaching of a paper filter pack containing both tea leaves and sweetener. Also in 2013, Applicant began selling a foiled-packed, pre-sweetened loose tea (for use in a paper-coffee filter) to produce 3 gallon batches of sweet tea in automatic iced tea brewer. Additionally, Applicant began selling quart-size ice tea bags under its Southern Breeze® brand that produced sweet teas as early as the Summer of 2015.

Currently, food service outlets generally make flavored iced tea in one of two ways. They either use a regular iced tea pouch with flavoring syrup, or a flavored iced tea pouch that includes tea and flavor blended together. The first method allows food service outlets to only stock one type of tea pouch, but they must stock flavoring syrups and assign labor to mix the flavoring into the iced tea. This reintroduces the problem of variability in the finished iced tea product and the overall cost of tea pouches and syrup is relatively high. The second approach is more cost efficient but requires the restaurant to stock multiple types of large (e.g., approximately 3 pounds) flavored iced tea pouches—which takes up an undesirable amount of shelf space or may be in excess of the demand for one or more particular flavored iced tea, resulting in waste.

Thus, there is a need in the food service industry for a system that provides the consistency of pre-packaged brewed beverages along with the flexibility of providing optional flavoring with the same consistency food service operations have come to expect from their plain sweetened brewed beverages. There is an additional need for a system that takes up less-shelf space while providing these advantages. There is an associated need for a brewed beverage filter product that provides even greater consistency between batches. These needs are variously met and other advantages provided by one or more of the inventive concepts disclosed by the present application.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

The present disclosure is directed, in part, to a supplemental flavor pack for use in a beverage (for example, but not limited to, tea, coffee) brewer in association with one of the various commercially available (i.e., pre-existing) beverage filter packs, such as “sweet tea,” to form a desired composite flavor profile (e.g., raspberry- or peach-flavored sweet tea). Each pre-existing beverage filter pack has a known beverage substrate.

The supplemental flavor pack allows food service outlets to use the tea pouches they already stock along with an inexpensive and small flavoring pouch. This has the benefit of reducing complexity, so the finished product is the same every time, reduces waste and inefficiency because the base ingredient is the same across all of the food service outlet's iced teas, thus reducing cost, inventory, and storage and shelf space requirements.

The supplemental flavor pack comprises a water permeable container (e.g., a paper filter pouch or open-mouthed paper filter basket) containing one or more granulated flavor particles, the granulated flavor particles contributing to a supplemental flavor profile; one or more granulated acids contributing to said supplemental flavor profile; and a bulking agent. The particle size of at least about 90 wt % of the granulated flavor particles, granulated acids, and bulking agent is above U.S. mesh 50 with less than or equal to about 1 wt % being above U.S. mesh 10. The granulated flavor particles and granulated acids are in formulated amounts to balance out the known beverage substrate produced by the pre-existing beverage filter pack while supplementing it with the supplemental flavor profile to form a desired composite flavor profile. The supplemental flavor pack may further include an anti-caking agent.

The one or more granulated acids may be citric acid, malic acid, ascorbic acid, tartaric acid, lactic acid or combinations thereof. The bulking agent may comprise more than 40 wt % of the supplemental flavor pack. The bulking agent may be a botanical bulking agent, such as hibiscus or rose hips. A botanical bulking agent might contribute to the supplemental flavor profile, such that the formulated amounts of the one or more granulated acids needed to balance out the known quantity of sugar in the known beverage substrate may be materially reduced.

The known beverage substrate includes whether the pre-existing beverage filter pack is coffee-based, tea-based, or otherly-based as well as the known quantity of sugar. The formulated amounts of granulated acid needed to balance out this known flavor sub state may result in a sugar to acid ratio of about 190 to about 200 parts of sugar to 1 part acid. However, in embodiments, where the bulking agent is hibiscus or hibiscus-like acidic ingredients such as lemon peel, orange peel, the sugar to acid ratio may be increased to between about 275 and about 300 parts of sugar to 1 part acid.

The present disclosure is directed, in another part, to a method of making a flavored brewed beverage in a beverage brewing apparatus that comprises: (a) placing a pre-existing beverage filter pack having a known beverage substrate into the brew basket; (b) placing a supplemental flavor pack into the brew basket, wherein said supplemental flavor pack comprises: (1) a water permeable container; (2) one or more granulated flavor particles within said water permeable container, said one or more granulated flavor particles contributing to a supplemental flavor profile; (3) one or more granulated acids disposed within said water permeable container contributing to said supplemental flavor profile; and (4) a bulking agent within said water permeable container, wherein the particle size of at least about 90 wt % of said granulated flavor particles, said granulated acids, and said bulking agent is above U.S. mesh 50 with less than or equal to about 1 wt % being above U.S. mesh 10 and said granulated flavor particles and granulated acids are in formulated amounts to balance out said known beverage substrate produced by said pre-existing beverage filter pack while supplementing said known beverage substrate with said supplemental flavor profile to form a desired composite flavor profile; (c) placing a container beneath the brew basket to capture brewed liquid falling from the brew basket; and (d) running the brew cycle of the automated beverage brewing apparatus.

The method of making a flavored brewed beverage in a beverage brewing apparatus may further comprise diluting the captured brewed liquid in the container. The one or more granulated acids disposed in the water permeable container may be selected from the group comprising citric acid, malic acid, ascorbic acid, tartaric acid, lactic acid and combinations thereof. The bulking agent disposed in the water permeable container may be a botanical bulking agent (e.g., hibiscus, rose hip or a combination thereof), which may contribute to the supplemental flavor profile.

The method of making a flavored brewed beverage in a beverage brewing apparatus may further comprise producing the pre-existing beverage filter pack, wherein producing involves: (a1) placing crystallized white sugar having uniform particle size greater than ASTM Mesh 30 into a coating pan; (a2) rotating the coating pan at 10-20 revolutions per minute to keep the crystallized white sugar constantly moving; (a3) spraying potable water onto the crystalized sugar over the span of about 60-120 seconds while the coating pan continues rotating; (a4) adding tea particulate and a small amount of a binding agent to the rotating mass of moistened crystalized sugar over the span of about 5 minutes to form wet sugared tea; (a5) drying the wet sugared tea resulting in dried sugared tea having less than 0.5% moisture; (a6) filling a paper filter pouch with a pre-determined amount of dried sugared tea; and (a7) sealing the paper filter pouch. The binding agent may be food-grade maltodextrin and the potable water may be produced by reverse osmosis.

These and other aspects of the disclosure will be further explained below.

### BRIEF DESCRIPTION OF THE DRAWINGS

To assist those of ordinary skill in the relevant art in making and using the subject matter hereof, reference is made to the appended drawings, which disclose non-limiting and non-exhaustive embodiments that are not intended to be drawn to scale, and in which like reference numerals are intended to refer to similar elements for consistency, unless otherwise specified. For purposes of clarity, not every component may be labeled in every drawing. Non-limiting embodiments of this disclosure are described in reference to the following drawings.

FIG. 1 is a perspective view of one potential embodiment of a supplemental flavor pack alongside one particular pre-existing beverage filter pack illustrating certain potential aspects of the inventive concepts described herein.

FIG. 1A is a top plan view of the supplemental flavor pack of FIG. 1.

FIG. 1B is a cross-section view of the supplemental flavor pack of FIG. 1, taken along sightline 1B-1B in FIG. 1A.

FIG. 2 is a front elevational view of a commercial beverage brewing apparatus having a brew basket and a container for receiving liquid from the brew basket.

FIG. 3 is a perspective elevational view of the commercial beverage brewing apparatus of FIG. 2 illustrating the removal of the brew basket.

FIG. 4 is a plan perspective view of the inside of the brew basket of the commercial beverage brewing apparatus of FIG. 2.

FIGS. 5 and 6 illustrate a person placing a pre-existing beverage filter pack into the brew basket of the commercial beverage brewing apparatus of FIG. 2.

FIGS. 7 and 8 illustrate a person placing a supplemental flavor pack on top of the pre-existing beverage filter pack already in the brew basket of the commercial beverage brewing apparatus of FIG. 2.

FIG. 9 is a perspective elevational view of the commercial beverage brewing apparatus of FIG. 2 illustrating the replacement of the brew basket onto the apparatus.

FIG. 10 is a perspective elevational view of an industrial coating pan containing a crystalized sugar being moistened with water as it is rotated.

FIG. 11 is a front elevational view of the industrial coating pan of FIG. 10 illustrating the mixing of the wetted crystalized sugar with tea leaves along with a binding agent.

FIG. 12 is a perspective plan view of an industrial dryer with a belt conveyor showing the wet, sugared tea being fed therethrough in order to dry the sugar tea before packaging.

FIG. 13 is a flow diagram of the process of making a flavored brewed beverage in a brewing apparatus.

FIG. 14 is a flow diagram of the process of producing a pre-existing beverage filter pack with improved performance characteristics.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. The following detailed description and/or arrangement of the components set forth in the following description or illustrated in the drawings is, therefore, not to be taken in a limiting sense, unless otherwise explicitly noted.

Unless otherwise defined herein, mechanical and technical terms used in connection with the present disclosure shall have the meanings that are commonly understood by those of ordinary skill in the art. Further, unless otherwise required by context, singular terms shall include pluralities and plural terms shall include the singular. The foregoing constructions are generally produced according to conventional methods well known in the art. Still, it is to be understood that the phraseology and terminology employed herein is for purposes of description, and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments illustrated herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. For instance, the term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item. The substantiality of such may depend on a variety of factors understood by a person of ordinary skill in the art having the present specification, drawings, and claims before them.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

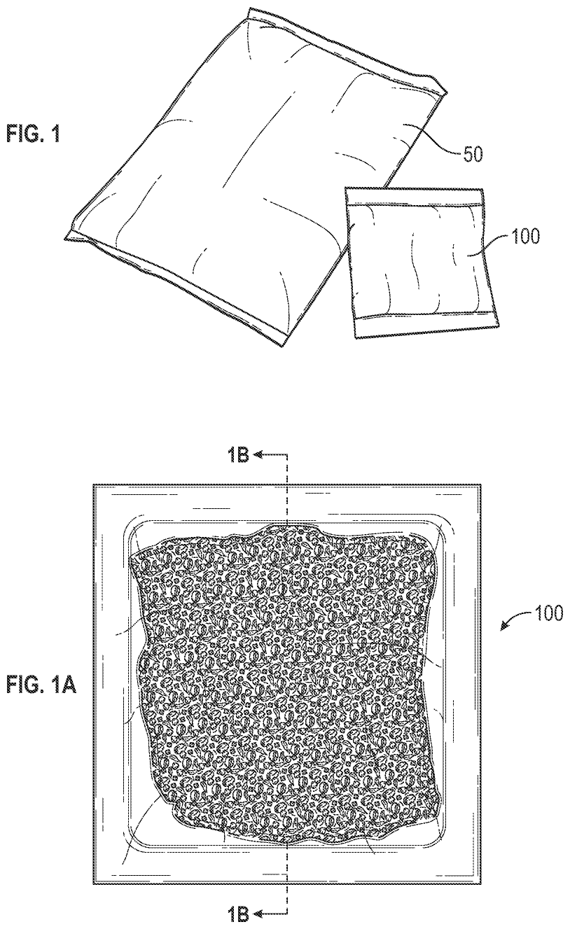

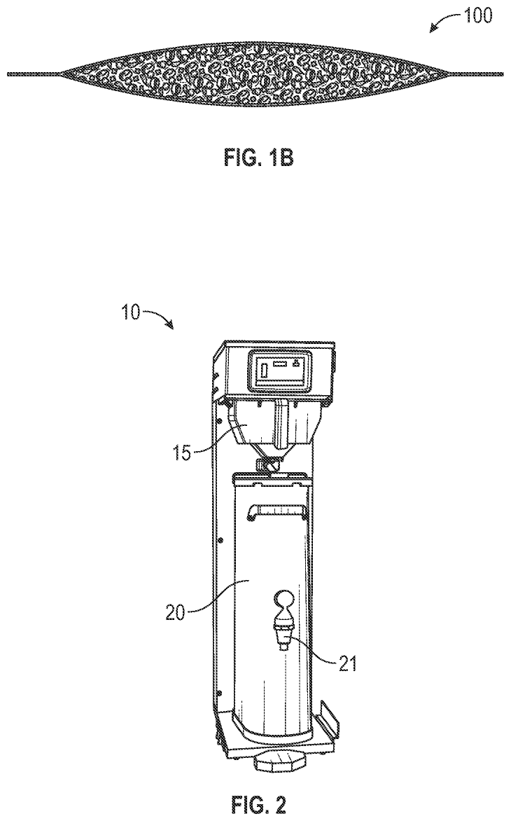

FIG. 1 of the drawings is a perspective view of one potential embodiment of a supplemental flavor pack 100 alongside a pre-existing beverage filter pack 50. As illustrated, both pre-existing beverage filter pack 50 and supplemental flavor pack 100 comprise paper-filter based, heat sealed packaging designed to substantially retain the contents thereof during shipping, storage and manual insertion into a brew basket of a beverage brewing apparatus.

Pre-Existing Beverage Filter Pack (50)

Each pre-existing beverage filter pack 50 (see FIG. 1) has a known beverage substrate. In particular, there are beverage filter packs 50 generally, but not exclusively, enclosed in water permeable pouches, that contain a pre-determined quantity of a brewed beverage (e.g., tea, coffee, yerba mate, dandelion, chicory or flavored concentrates), a predetermined amount of sweetener and optional food-quality additives (e.g., anti-caking agents, preservatives, stabilizers). Where tea is included in the beverage filter pack 50 it may comprise a blend of one or more teas (e.g., black teas, green teas, white teas, yellow teas, oolong teas, decaffeinated teas, herbal teas, or some combination thereof) each tea may or may not be ground to a particular particle size. Where coffee is included in the beverage filter pack 50 it may comprise one or more geographically sourced beans that may be blended together. Those coffee beans are processed in a pre-determined manner including, but not limited to, roasting (dark, medium, or light), grinding (fine, medium, coarse), and potentially decaffeinating. The flavored concentrates in the beverage filter pack 50 may include, for example, lemonade, limeade, and fruit punch. The sweetener in the beverage filter pack 50 may comprise for example one or more types of sweetener including but not limited to stevia, monk fruit extract, aspartame, saccharin, sucralose, and sucrose/regular sugar, fructose, glucose, maltose, each of which may have pre-determined known particle sizes.

As a result of pre-determined selections (often made by third-party vendors), each pre-existing beverage filter pack, such as the pre-existing beverage filter pack 50, will have a known beverage substrate. That known beverage substrate may be determined by obtaining the specifications for each pre-existing beverage filter pack from its respective manufacturer or distributor. The known beverage substrate of a particular pre-existing beverage filter pack may also (or alternatively) be determined by testing one, two, or three, or more preferably a representative sampling of each pre-existing beverage filter pack to determine the known beverage substrate for that pre-existing beverage filter pack.

Accordingly, it should be understood that while the present specification discusses a singular pre-existing beverage filter pack, it is contemplated that manufacturers/distributors have and will continue to formulate and distribute pluralities of different pre-existing beverage filter packs. In other words, the term “pre-existing” is not intended to convey that only beverage filter packs that predate the present disclosure are contemplated for use with the supplemental flavor pack 100 (see, e.g., FIGS. 1, 1A, 1B). Rather, the present disclosure provides a framework for those of ordinary skill in the art to produce specific supplemental flavor packs 100 to provide a supplemental flavor profile to form a desired composite flavor profile with the known flavor profile of each particular pre-existing beverage filter pack that may be designed and distributed in the future.

So, for example, but not by way of limitation, one pre-existing beverage filter pack—advertised as producing 3 gallons of sweet tea—may contain approximately 3 pounds of granulated sugar (including particle sizes in the range of US Mesh 3 to 35) and approximately three ounces of a particular black tea blend in a water permeable paper-filter pouch. In this example, the manufacturer may disclose that the beverage filter pack produces a sweet tea having a Brix of 11.5°. The same or another manufacturer may, in a second example, sell their pre-existing beverage filter pack—advertised as producing 3 gallons of sweet tea—that contains approximately 2.5 pounds of granulated sugar and approximately three ounces of a particular green tea in a water permeable paper-filter pouch. In this example, the manufacturer may disclose that the beverage filter pack produces a sweet green tea having a Brix of 10°.

Each of these illustrative examples presents a particular, pre-determined flavor substrate that can be determined based on the respective manufacturers' disclosures. Alternatively (or even additionally), one, two or a represented sampling of pre-existing beverage filter packs may be obtained. The contents of those pre-existing beverage filter packs may be analyzed for content and consistency, including the weights, particle sizes, pH, and the like of the constituents of the pre-existing beverage filter packs. The brewed product may also be produced with the pre-existing beverage filter packs according to the manufacturer's instructions. The resulting produced beverage can be analytically (e.g., colorimeter, pH-testers, spectroscopy, turbidimeter) and/or subjectively (e.g., smell, taste, appearance) considered. Results of such consideration may be recorded and maintained in a database in association with commercial information regarding each pre-existing beverage filter pack 50 tested.

Supplemental Flavor Pack (100)

Once a known beverage substrate is determined for the pre-existing beverage filter pack 50 one or more supplemental flavor packs 100a, 100b, . . . 100n may be developed for use with that pre-existing beverage filter pack. Each supplemental flavor pack 100 (see FIGS. 1, 1A and 1B) comprises a water permeable container containing one or more granulated flavor particles, one or more granulated acids, and a bulking agent. The water permeable container may be comprised by filter paper formed into a sealed pouch (as illustrated) or an open-mouthed basket. The water permeable container may be any shape or size (but preferably not so large as to make its insertion into the brew basket of a commercial iced maker too cumbersome). For example, but not by way of limitation, the container may be sized to substantially conform to, or to not exceed, the size of a brew basket of a commercial iced maker. In the embodiment best shown in FIG. 1, the supplemental flavor pack 100 is much smaller than pre-existing beverage filter pack 50. In one example, the supplemental flavor pack 100 may be on the order of 1 ounce, while its associated pre-existing beverage filter pack 50 is on the order of 3 pounds.

In one embodiment, information regarding the supplemental flavor pack 50 may be embossed, stitched, or printed on the water permeable container in food-grade ink to assist food service workers in identifying the type of the supplemental flavor pack (e.g., supplemental flavor profile and brand/size of pre-existing beverage filter pack for which it was designed for use in co-brewing) while supplementing the known beverage substrate with a supplemental flavor profile to form a desired composite flavor profile. It is contemplated that the supplemental flavor pack 100 may be individually packaged, shipped, and stored in a substantially air-tight, water resistant package (e.g., shrink wrapped) to minimize (if not completely avoid) degradation of the constituents of the supplemental flavor pack 50. Those individually packaged supplemental flavor packs may be placed into a paperboard box with one or more other individually packaged supplemental flavor packs. These paperboard boxes may have printed on them information regarding the supplemental flavor pack contained therein such as the type of flavor pack, nutritional information and instructions for use. In turn, two of more of those paperboard boxes may be placed into a corrugated paperboard box for shipping to various distributors and ultimately for distribution to food service locations.

At a high level, the supplemental flavor profile of the supplemental flavor pack 100 can be thought of as supplementing the known beverage substrate with a supplemental flavor profile to form a desired composite flavor profile. For example, a pre-existing “sweet tea” could be made into a peach sweet tea by adding the smaller supplemental flavor pack 100 along with the larger pre-existing beverage filter pack 50 in the brew basket of a beverage brewing apparatus for co-brewing. The supplemental flavor profile that could be added to “tea-based” known beverage substrates may include, but are not limited to: apple, blackberry, blueberry, chai, cherry, cinnamon, cranberry, guava, hibiscus, kiwi, lemon, lemonade (i.e., an Arnold Palmer), lychee, mango, mint, passion fruit, orange, peach, pear, pineapple, pomegranate, raspberry, strawberry, watermelon, or even a blended (e.g., “apple-cherry”, “berry”, “tropical”) flavoring. Similarly, for “coffee-based” known beverage substrates, the supplemental flavor profile may add, by way of example (and not limitation): almond, amaretto, caramel, cinnamon, chocolate, hazelnut, mint, mocha, pecan, peppermint, toffee, vanilla, or even blended flavors (e.g., “caramel-chocolate”, “caramel-pecan”, “vanilla-almond”).

These flavor profiles are provided by the one or more granulated flavor particles (preferably natural), each of which are included in an amount formulated to contribute to the desired composite flavor profile, along with the other constituents contained in the supplemental flavor pack 50. These granulated flavor particles may comprise encapsulated flavor particles. At least about 90 wt % of the one or more granulated flavor particles has a particle size above U.S. mesh 50 with less than or equal to about 1 wt % being above U.S. mesh 10.

As used in this specification, wt % refers to the weight of a particular constituent as a percentage of the total weight of all of the constituents in the mixture, as measured with a weigh scale such as Penn Scale FC6300™ Formula control scale. In other words, in the preferred embodiment of the present invention, the amounts of granulated flavor particles, granulated acid, and bulking agents would each be separately weighed, their weights added together and the wt % of the granulated flavor particles, for example, would be calculated by taking its weight and dividing by the total weight.

In an alternative embodiment, the flavor pack may additionally (or even alternatively) include a functional component comprising one or more antioxidants, minerals, prebiotics, probiotics, vitamins, and other functional dietary supplements (e.g., ashwagandha, ginger (root), 1-theanine, turmeric, valerian root). These functional components may or may not contribute to the acidity and/or human-perceivable taste profile of the beverage. To the extent, the functional components would contribute to the flavor profile in a manner that would be perceivable by patrons, the formulation may be adjusted accordingly.

The one or more granulated acids disposed in the supplemental flavor pack 100 also contribute to the supplemental flavor profile. The one or more granulated acids may be selected from the group comprising citric acid, malic acid, ascorbic acid, tartaric acid, lactic acid and combinations thereof. At least about 90 wt % of the one or more granulated acids has a particle size above U.S. mesh 50 with less than or equal to about 1 wt % being above U.S. mesh 10. The one or more acids serve to help balance out the sugar content of the pre-existing beverage filter pack and may provide further contributions to result in the desired composite flavor profile. Without acid to offset the pre-existing sugar content of the pre-existing beverage filter pack 50, the addition of the granulated flavor particles to the known beverage substrate of the pre-existing beverage filter pack may result in a beverage that is less desirable (e.g., too sweet) for consumption by average consumers. Accordingly, the supplemental flavor pack 100 includes a formulated amount of the one or more acids approximated to contribute—along with the known beverage substrate and the formulated amount of the one or more granulated flavor particles—to the formation of the desired composite flavor profile.

In one embodiment, the amount of the one or more granulated acids to formulated to balance out the sugar in the known flavor substate is designed to achieve a sugar to acid ratio of about 190 to about 200 parts of sugar to 1 part acid, with substantially all of the sugar included in this ratio being contributed to the resulting beverage by the pre-existing beverage filter pack 50.

In the example of a pre-existing beverage filter pack 50 that is “tea-based” with about 3 pounds of sugar to produce 3 gallons of sweet tea and not yet accounting for the contributions of the other constituents within the supplement flavor pack 100, this ratio would require about 7 grams of malic/citric acid to achieve the desired composite flavor profile.

A bulking agent is also disposed in the supplemental flavor pack 100. The bulking agent may comprise more than 40 wt % of the contents of the supplemental flavor pack 100. At least about 90 wt % of that bulking agent has a particle size that is above U.S. mesh 50 with less than or equal to about 1 wt % being above U.S. mesh 10. Bulking agents allow for uniform dispersion of other ingredients, promote consistent fill weights of the supplemental flavor pack 100 during packaging, and promote improved solubility in automated beverage brewing machines.

In one embodiment, the bulking agent contained in supplemental flavor pack 100 may be a botanical bulking agent, such as hibiscus or rose hips. The botanical bulking agent may contribute to the supplemental flavor profile. Some botanical bulking agents may also provide vibrant color and/or a fruity flavor profile. In addition, botanical bulking agents may balance the sharp acidic taste of one or more of the granulated acids. Moreover, as a result of using a botanical bulking agent, the formulated amounts of the one or more granulated acids needed to balance out said known quantity of sugar in the known beverage substrate may be materially reduced. In one example embodiment, where the botanical bulking agent is hibiscus, the sugar to acid ratio may be increased to between about 275 and about 300 part of sugar to 1 part acid because hibiscus adds to the acidity of the resulting beverage. Another benefit of the hibiscus bulking agent may be found in its addition of a bright reddish pink coloring to the resulting beverage. This is because the dried leaves of the hibiscus are pink/red interspersed with tan.

In another example, where the botanical bulking agent is rose hips, the sugar to acid ratio remains substantially unchanged from the ratio used in the absence of a botanical bulking agent. It is contemplated that conventional fiber-based bulking agents, such as maltodextrin could be used as the bulking agent. Regardless of the type of bulking agent used, the potential contribution of that bulking agent (or lack thereof) to the supplemental flavor profile should be considered in formulating the amounts of the other constituents of the supplemental flavor pack 100. Bulking agents such as starch, inulin, gum acacia, may be used in the supplemental flavor pack.

To sum, the contents of supplemental flavor pack 100 approximately comprises at least 40% bulking agent(s), at least 20% granulated flavors, and at least 15% granulated acid (≥15%). The resulting pH range of the flavored brewed beverage measured using a Oakton™ pH meter may be approximately less than 4.0.

The supplemental flavor pack 100 may further include an anti-caking agent. This anti-caking agent preferably meets the particle size specifications for the other constituents of the supplemental flavor pack 100. In one embodiment, the anti-caking agent may be silicon dioxide. In another embodiment, the anti-caking agent may be magnesium stearate. In yet another embodiment the anti-caking agent may be a natural substance. Where included in the contents of the supplemental flavor pack 100, the anti-caking agent may comprise 1-2% of its contents.

As discussed above, at least about 90 wt % of each of these components have a particle size greater than or equal to U.S. mesh 50 with less than or equal to about 1 wt % being above U.S. mesh 10. Granulated acid and granulated flavor are critical to achieve uniform solubility, blend consistency and machinability, hence a more uniform taste through auto-brewer systems. As such, these formulations provide superior performance on packaging lines and in automatic beverage brewing machines.

Where the supplemental flavor pack 100 is designed to provide a raspberry supplemental flavor profile for a pre-existing “sweet tea” beverage filter pack, pack 100 may preferably contain hibiscus TBC, encapsulated granular natural raspberry flavor, and granular malic acid. Where the supplemental flavor pack 100 is designed to provide a peach supplemental flavor profile for a pre-existing “sweet tea” beverage filter pack, pack 100 may preferably contain rose hip TBC, encapsulated granular natural peach flavor, and granular citric acid. Where the supplemental flavor pack 100 is designed to provide a “tropical” supplemental flavor profile for a pre-existing “sweet tea” beverage filter pack, pack 100 may preferably contain rose hip TBC, encapsulated granular natural flavors, and granular malic (and/or citric) acid.

FIG. 2 of the drawings is a front elevational view of a commercial beverage brewing apparatus 10 having a removable brew basket 15 and container 20 for receiving liquid from brew basket 15. Commercial beverage brewing apparatus 10 generally contains a mechanism for heating water to a substantially pre-determined temperature (i.e., 195-212° F.), which may be pre-set at the factory or may be field-adjustable or otherwise programmable. Water may be supplied to the commercial beverage brewing apparatus via a water-supply line, or the water may be added by pouring water from a vessel into the reservoir of apparatus 10. Commercial beverage brewing apparatus 10 deliver a substantially pre-determined amount of water (e.g., 1, 1.5 or 3 gallons) which may be pre-set at the factory or may be field-adjustable or otherwise programmable. Some commercial beverage brewing apparatuses distribute all of the substantially pre-determined amount water through the brew basket. In others, a portion of the pre-determined amount of water bypasses the brew basket to dilute the concentrated liquid tea that drips into container 20 from brew basket 15. As illustrated, container 20 may have a spigot 21 for dispensing the resulting brewed beverage from the container 20. Moreover, container 20 may be easily removed from beverage brewing apparatus 10 and placed in a convenient location for dispensing the brewed beverage. With container 20 removed from beverage brewing apparatus 10, another container (not shown) may be placed under the brew basket 15 and another subsequent brewing cycle may be started.

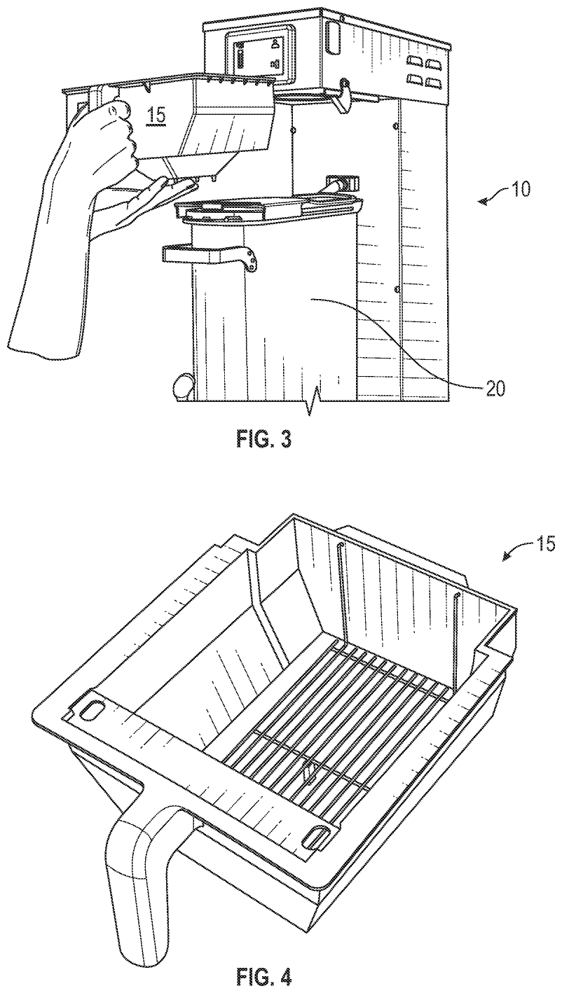

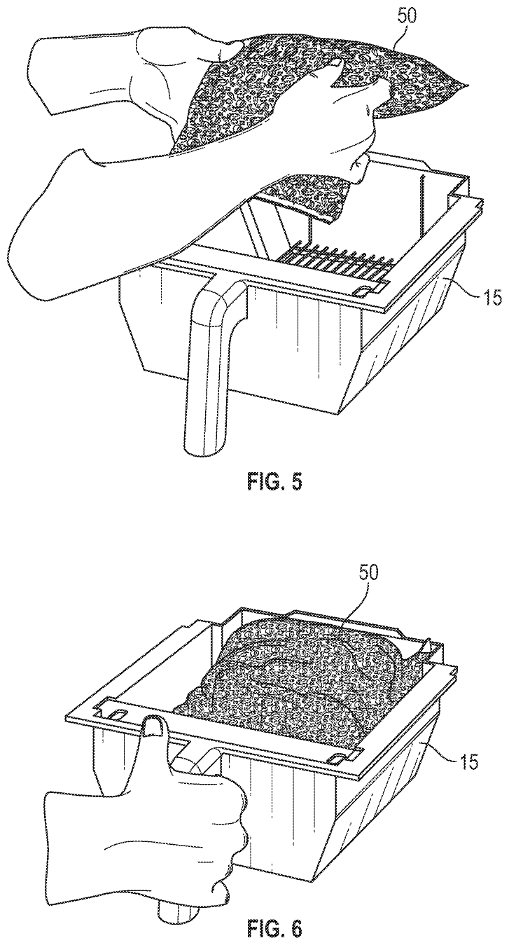

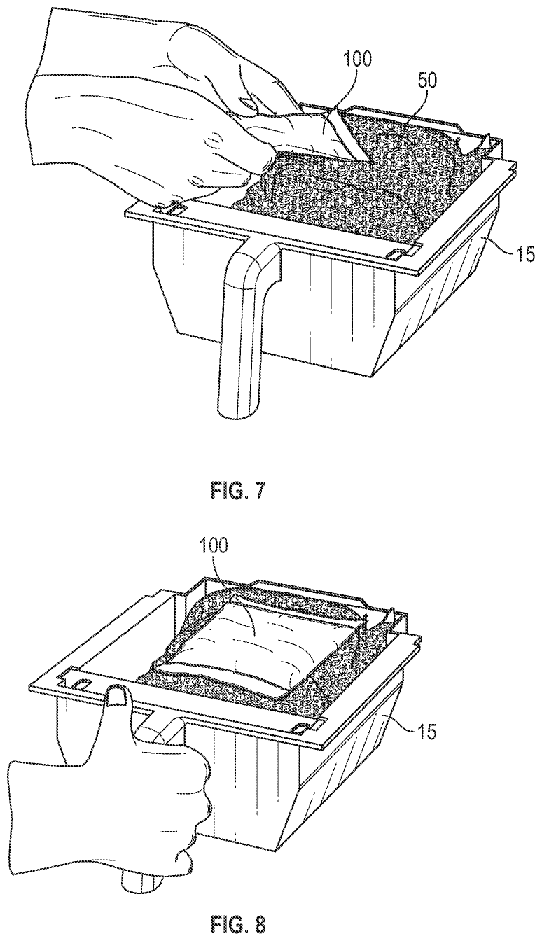

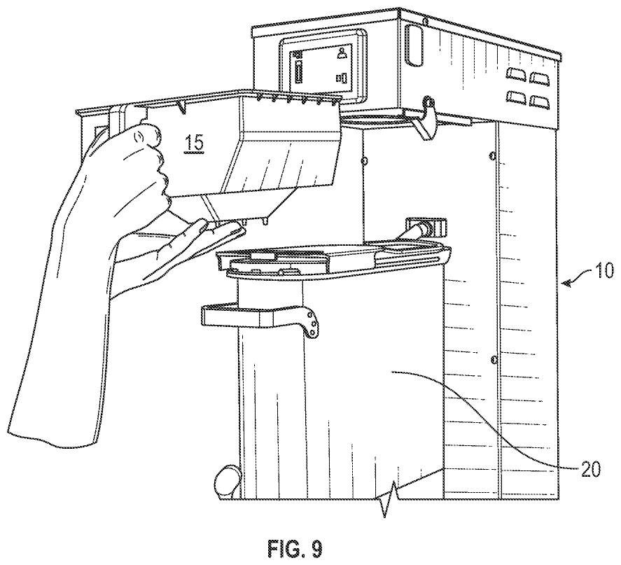

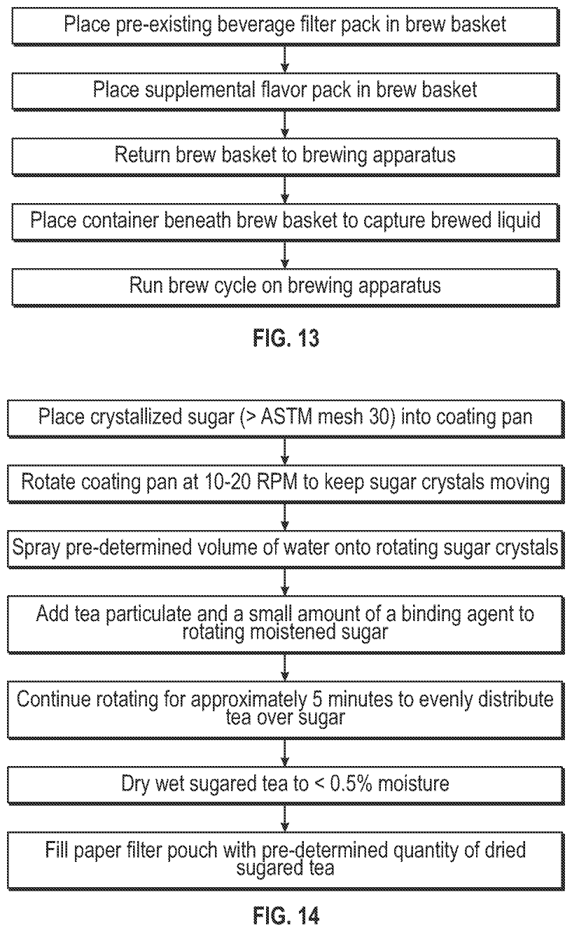

Operation of the present invention with an automatic iced tea brewer may generally follow the process set forth in FIG. 13, and generally illustrated in FIGS. 3-9. As shown in FIG. 3, the server removes the brew basket from the filter basket rails of the beverage brewing apparatus 10. As shown in FIG. 4, brew basket 15 may have a wire platform upon which the pre-existing beverage filter pack sits. As further illustrated in FIGS. 5 and 6, the server places the pre-existing beverage filter pack 50 into the brew basket 15. Then, the server places the supplemental flavor pack 100 on top of the pre-existing beverage filter pack 50 in the brew basket 15, and places brew basket 15 back into the automatic iced tea brewer as illustrated in FIGS. 7, 8 and 9. It is also contemplated that the supplemental flavor pack 100 may be placed into the filter basket 15 by the server prior to placement of the pre-existing beverage filter pack 50. An empty container 20 is preferably positioned beneath the brew basket 15 before the server starts the brew cycle. At the completion of the brew cycle, the server will preferably stir the liquid contents in container 20 to better incorporate the sugar solids and liquid tea. The server may also remove container 20 from apparatus 10 either before or after stirring.

### Preferred Embodiment (200) of Pre-Existing Beverage Filter Pack (50)

One potential preferred embodiment 200 of a pre-existing beverage filter pack 50 is disclosed. Pre-existing beverage filter pack 200 is a paper-based, heat sealed filter pack containing a preferred blend of tea and sugar. Pre-existing beverage filter pack 200 may come in a variety of sizes, such as a first size containing approximately 3.3 lbs. of the preferred sugared tea blend. This first size may be optimized for use with an automated iced tea brewer that dispenses approximately 1.5 gallons of water directly to container 20 (bypassing brew basket 15) and dispenses another 1.5 gallons of water over the contents of the brew basket 15 (i.e., pre-existing beverage filter pack 200 and supplemental flavor pack 100), such that approximately 1.5 gallons of concentrated flavored iced tea flows from the brew basket 15 into container 20. After brewing, it is contemplated that the mixture should be stirred well in the urn to better incorporate the sugar solids and liquid tea.

A second size of pre-existing beverage filter pack 200 may contain 1 ounce of the preferred sugared tea blend optimized for use in a standard tea or pour-over coffee brewer to produce a ½ gallon of concentrated tea to be poured into a one-gallon pitcher that already has a ½ gallon of ambient water to produce one gallon of iced tea. This second sized pre-existing beverage filter pack would also preferably use less filter-paper. This second sized pre-existing beverage filter pack could also be matched with a supplemental flavor pack designed specifically for use with the known beverage substrate of this smaller pre-existing beverage filter pack 200. Preferably, after the concentrated (potentially flavored) tea is added to the ambient water, the mixture is stirred well in the pitcher to incorporate the sugar solids and liquid tea.

The preferred sugared tea blend was created to better ensure that substantially all of the particles in the blend include both tea and sugar in order to promote more harmonious brewing of the sweet tea product in automatic iced tea brewing apparatus 10. Generally, the process of producing the preferred sugared tea blend involves slightly wetting the surface of sugar crystals with a spray of water, evenly sprinkling (preferably in stages to ensure even mixing) on to these wet sugar crystals a mixture of black tea and a binding agent, such as maltodextrin, which is constantly mixed to make the compound homogeneous. Preferably, the maltodextrin is food-grade and more preferably of a high-quality (such as MALTRIN® M100 currently distributed by Grain Processing Corporation of Muscatine, Iowa). Due to the constant mixing of sugar crystals (the surface of which is wet and sticky) and the presence of the binding agent (e.g., maltodextrin), the black tea binds to the surface of the sugar crystals uniformly and completely. This “sugared tea” is then dried in a warm air drier at a controlled temperature until the moisture content is reduced to 0.5% level and packed in a filter pouch. The desired sugar-to-tea ratio in the filter pouches is 14:1 which is intended to result in a Brix range of 10% to 12%. The general process to make sugared tea compound may be carried out in two ways.

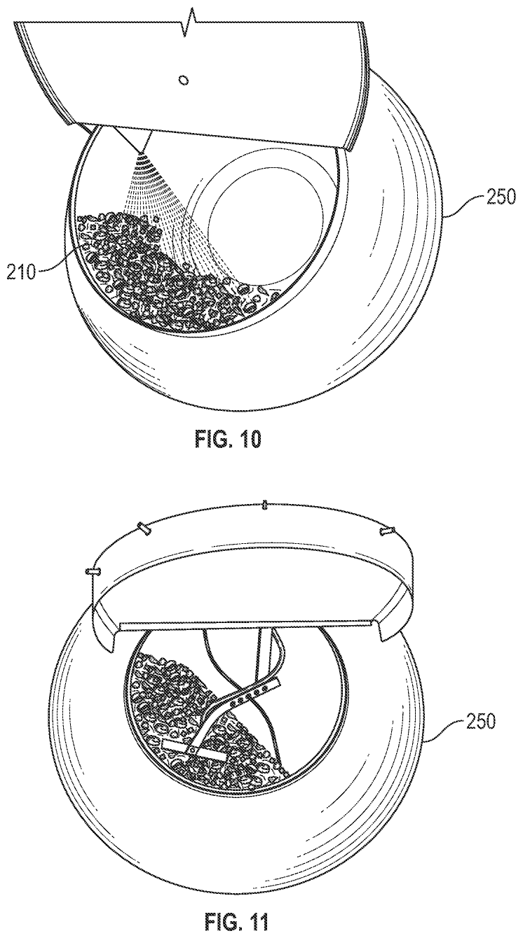

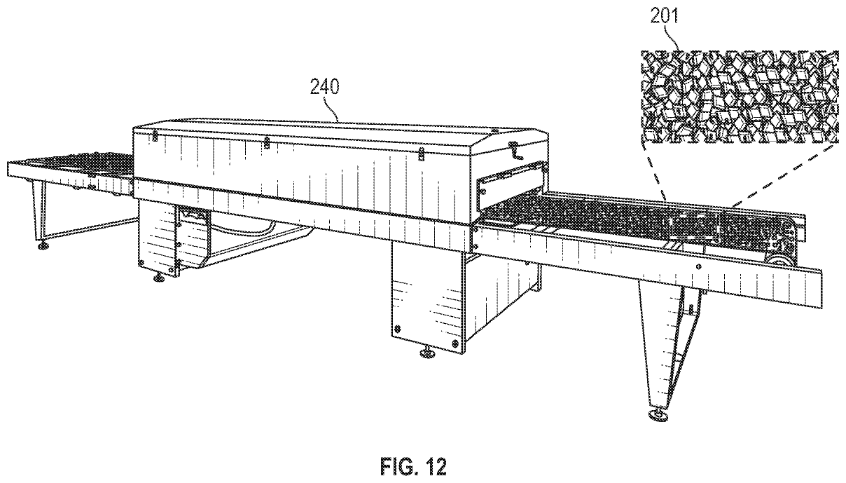

Semi Batch Process (FIG. 14)
1) about 30 kg crystallized white sugar 210 having rather uniform particle size greater than ASTM Mesh 30 (i.e., 600 microns) is added into a coating pan 250 rotating at 10 to 20 RPM to keep the sugar crystals constantly moving.
2) As illustrated in FIG. 10, about 750 mL of potable water (preferably pre-processes by reverse osmosis) is added onto the crystalized sugar 210 over the span of about 60-120 seconds while the coating pan 250 continues rotating.
3) As illustrated in FIG. 11, about 2.14 kg of black tea (and the small amount of food grade maltodextrin) is added on to the constantly rotating mass of moistened sugar over the span of about 5 minutes during which time the crystallized sugar, maltodextrin and tea become a uniform collection of wet sugared tea 220.
4) As illustrated in FIG. 12, the wet sugared tea 220 is then discharged from the coating pan 250 to a belt conveyor which takes the wet sugared tea 220 to a belt dryer 270, where the wet sugared tea 220 is dried to below 0.5% moisture in an air drier at very low temperatures, with the air being free of moisture resulting in the dried sugared tea blend 201. The dried sugared tea blend 201 is packed in paper-filter based, single-compartment pouches at the desired weights (e.g., 3.3 lbs).

An alternate “continuous process” may be used to manufacture the sugared tea blend 201. A crystallized white sugar 210 having rather uniform particle size greater than ASTM Mesh 30 (i.e., 600 microns) is continuously added into a horizontal rotating drum through a feeding mechanism at a controlled rate (e.g., 30-40 kg/min). Pure water is added onto the sugar crystals using spray nozzles at the rate of about 1 liter/min to slightly moisten the sugar crystals 210. The moistened sugar is added into a horizontal rotating drum at the rate of 2.5 kg/min where it is coated with the selected blend of black tea, which may be continuously fed by a double screw feeding mechanism. The moist sugared tea is fed into a continuous vibratory dryer with perforated holes at the bottom and dried with moisture-free air fed from the bottom to dry the sugared tea to below 0.5% moisture. The dried sugared tea is dropped on to a belt conveyor for inspection and packaging into a filter pouch.

In a preferred embodiment, a minimum of 95% of the particle in the dried sugared tea blend 201 are greater than ASTM mesh 40 (i.e., 420 microns). The preferred formulation of the dried sugared tea blend 201 may be 93.10 wt % Crystallized White Sugar (above ASTM Mesh 30); 6.65 wt % black tea (especially blended for iced tea) and 0.25 wt % maltodextrin. As can be seen, the sugar to tea ratio for the preferred blend would be 14:1. This results in a Brix range of 10° to 12° when no supplemental flavor pack and 3 gallons of water are used to make sweet tea using sugared tea blend 201.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristics. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A supplemental flavor pack for use in a beverage brewing apparatus in association with a pre-existing beverage filter pack having a known beverage substrate, the beverage brewing apparatus having a brew basket, a container for receiving liquid from said brew basket, the supplemental flavor pack comprising:
a water permeable container;
one or more granulated flavor particles within said water permeable container, said one or more granulated flavor particles contributing to a supplemental flavor profile;
one or more granulated acids disposed within said water permeable container contributing to said supplemental flavor profile; and
a bulking agent within said water permeable container,
wherein the particle size of at least about 90 wt % of said granulated flavor particles, said granulated acids, and said bulking agent is above U.S. mesh 50 with less than or equal to about 1 wt % being above U.S. mesh 10 and said granulated flavor particles and granulated acids are in formulated amounts to balance out said known beverage substrate produced by said pre-existing beverage filter pack while supplementing said known beverage substrate with said supplemental flavor profile to form a desired composite flavor profile.

2. The supplemental flavor pack of claim 1 wherein said known beverage substrate comprises a known quantity of sugar, said formulated amounts of said granulated acid to balance out said known flavor substate resulting in a sugar to acid ratio of about 190 to about 200 parts of sugar to 1 part acid.

3. The supplemental flavor pack of claim 2 wherein said one or more granulated acids are selected from the group comprising citric acid, malic acid, ascorbic acid, tartaric acid, lactic acid and combinations thereof.

4. The supplemental flavor pack of claim 2 wherein said bulking agent is a botanical bulking agent, said botanical bulking agent contributing to said supplemental flavor profile, such that the formulated amounts of said one or more granulated acids needed to balance out said known quantity of sugar in said known beverage substrate is materially reduced.

5. The supplemental flavor pack of claim 4 wherein said botanical bulking agent is hibiscus, said sugar to acid ratio is reduced to between about 275 and about 300 part of sugar to 1 part acid.

6. The supplemental flavor pack of claim 4 wherein said botanical bulking agent is rose hips.

7. The supplemental flavor pack of claim 4 further comprising an anti-caking agent.

8. The supplemental flavor pack of claim 2 wherein the bulking agent comprises more than 40 wt % of the supplemental flavor pack.

9. The supplemental flavor pack of claim 8 wherein the water permeable container is selected from the group comprising a filter-paper pouch and an open-mouthed filter-paper basket.

10. A method of making a flavored brewed beverage in a beverage brewing apparatus having a brew basket and a container for receiving liquid from said brew basket, the method comprising:
(a) placing a pre-existing beverage filter pack having a known beverage substrate into the brew basket;
(b) placing a supplemental flavor pack into the brew basket, wherein said supplemental flavor pack comprises:
(1) a water permeable container;
(2) one or more granulated flavor particles within said water permeable container, said one or more granulated flavor particles contributing to a supplemental flavor profile;
(3) one or more granulated acids disposed within said water permeable container contributing to said supplemental flavor profile; and
(4) a bulking agent within said water permeable container,
wherein the particle size of at least about 90 wt % of said granulated flavor particles, said granulated acids, and said bulking agent is above U.S. mesh 50 with less than or equal to about 1 wt % being above U.S. mesh 10 and said granulated flavor particles and granulated acids are in formulated amounts to balance out said known beverage substrate produced by said pre-existing beverage filter pack while supplementing said known beverage substrate with said supplemental flavor profile to form a desired composite flavor profile;
(c) placing a container beneath the brew basket to capture brewed liquid falling from the brew basket; and
(d) running the brew cycle of the beverage brewing apparatus.

11. The method of claim 10 further comprising diluting the captured brewed liquid in the container.

12. The method of claim 10 wherein said one or more granulated acids are selected from the group comprising citric acid, malic acid, ascorbic acid, tartaric acid, lactic acid, and combinations thereof.

13. The method of claim 10 wherein said bulking agent is a botanical bulking agent, said botanical bulking agent contributing to said supplemental flavor profile.

14. The method of claim 13 wherein said botanical bulking agent is selected from the group comprising hibiscus, rose hips, and combinations thereof.

15. The method of claim 10 further comprising producing the pre-existing beverage filter pack, wherein producing involves:
(a1) placing crystallized white sugar having uniform particle size greater than ASTM Mesh 30 into a coating pan;
(a2) rotating the coating pan at 10-20 revolutions per minute to keep the crystallized white sugar constantly moving;
(a3) spraying potable water onto the crystalized sugar over the span of about 60-120 seconds while the coating pan continues rotating;
(a4) adding tea particulate and a small amount of a binding agent to the rotating mass of moistened crystalized sugar over the span of about 5 minutes to form wet sugared tea;
(a5) drying the wet sugared tea resulting in dried sugared tea having less than 0.5% moisture;
(a6) filling a paper filter pouch with a pre-determined amount of dried sugared tea; and
(a7) sealing the paper filter pouch.

16. The method of claim 15 wherein the binding agent is food-grade maltodextrin.

17. The method of claim 15 further comprising producing the potable water by reverse osmosis.
